(19) United States
(12) Patent Application Publication
(10) Pub. No.: US 2024/0016701 A1
(43) Pub. Date: Jan. 18, 2024

(54) HIGH-DENSITY STERILE MAGAZINE

(71) Applicant: ATS Automation Tooling Systems Inc., Cambridge (CA)

(72) Inventors: Marty Juritsch, Cambridge (CA); James Dunnett, Cambridge (CA); Kaden Penner, Cambridge (CA)

(21) Appl. No.: 18/221,047

(22) Filed: Jul. 12, 2023

Related U.S. Application Data
(60) Provisional application No. 63/388,478, filed on Jul. 12, 2022.

(51) Int. Cl. A61J 1/16; B65B 3/00

(52) U.S. Cl. CPC A61J 1/16; B65B 3/003

(57) ABSTRACT

The high-density sterile magazine presented improves the transportation and storage of multiple vessels in the filling process. The magazine provides an access port providing access to a sterile interior volume and a first internal slot for aligning vessel carriers holding a number of vessels. The vessel carriers slide along the internal slot, sequentially presenting themselves at the access port. When interfaced with an isolator port of a filling machine, the vessel carriers are consecutively removed from the magazine. The compact rectangular design optimizes storage density, and the sterilisable or sterilized port opens perpendicular to the vessel carriers. A removable or puncturable barrier ensures sterility until access is required. Gravity-assisted sliding occurs when the magazine is oriented with the port lower than the top, enhancing efficiency. The magazine accommodates various vessel types, interfaces with a receiving port and seal, and offers sterile vessel transportation, storage, and filling in medical, pharmaceutical, and laboratory settings.

### CROSS-REFERENCE TO RELATED APPLICATIONS

The present application is a non-provisional application of U.S. Provisional Application No. 63/388,478 filed Jul. 12, 2023 the entirety of which is hereby incorporated by reference for all purposes.

### TECHNICAL FIELD

The present invention relates to the field of storage and transport of sterile vessels, such as vials, syringes, and ampules. More specifically, it pertains to a high-density sterile magazine designed to facilitate the transportation of multiple vessels while maintaining their sterility prior to filling of the vessels.

### BACKGROUND

In medical, pharmaceutical, and laboratory settings, the need for efficient storage and transport of sterile vessels is of utmost importance. Traditional methods of packaging and handling individual vessels, prior to filling, utilize structures such as a tub with nesting trays. The vessels may be sterile in the packaging but handling of the vessels prior to filing may introduce potentially unsterile environments. Depending on the packaging used the vessels may need to be sterilized before filling. An inline sterilization methods such as depyrogenation tunnels may be utilized for the sterilization and packaging process adding additional complexity and resources. The existing solutions are space inefficient, energy inefficient, can be time-consuming in the manufacturing process, and prone to contamination to human handling. Therefore, there is a need for an improved magazine system that enables the streamlined transportation of a plurality of vessels while preserving their sterility prior to filling with a liquid.

### BRIEF DESCRIPTION OF THE DRAWINGS

Further features and advantages of the present disclosure will become apparent from the following detailed description, taken in combination with the appended drawings, in which:

FIG. 1 shows a perspective view of a high-density sterile magazine with a sealed access port;

FIG. 2 shows a perspective view of the high-density sterile magazine with an open access port;

FIG. 3 shows a perspective view of the high-density sterile magazine in a loading position of a filling machine;

FIG. 4 shows a front end view of the high-density sterile magazine;

FIG. 5A shows is a view of the vessel carrier containing vials;

FIG. 5B shows is a view of the vessel carrier containing syringes;

FIG. 6 shows is a view a vessel carrier being removed from the high-density sterile magazine;

and

FIG. 7 shows an interior view of the high-density magazine.

It will be noted that throughout the appended drawings, like features are identified by like reference numerals.

### DETAILED DESCRIPTION

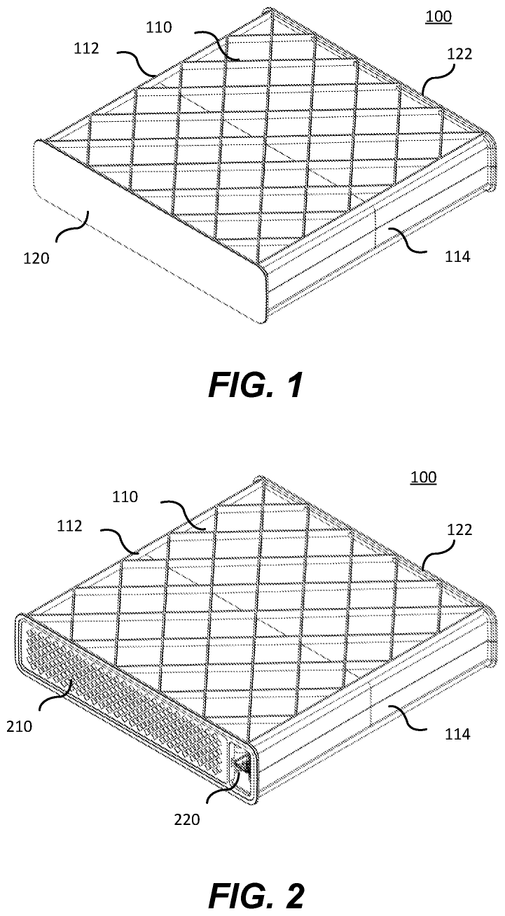

Embodiments are described below, by way of example only, with reference to FIGS. 1-7.

The present invention relates to a high-density sterile magazine designed for the transportation of multiple vessels, such as vials, syringes, and ampules prior to being filled in a medical, pharmaceutical or laboratory facilities. The magazine comprises an access port that provides access to a sterile interior volume. Inside the magazine, there is a first internal feature designed to receive an alignment feature of each vessel carrier. The vessel carriers are slidable along the first internal alignment feature, allowing them to be sequentially presented at the access port. Once opened, each vessel carrier is consecutively removed from the magazine via the access port when interfaced with an isolator port of an associated filling machine. The magazine allows for increased filling speed by simplifying the unloading of the vessels for filling while minimizing human interaction with the sterile process.

One general aspect includes a magazine body. The magazine body also includes an access port providing access to a sterile interior volume of the magazine body. The body also includes a first internal alignment feature in the interior of the magazine body, the first internal alignment feature for receiving an edge of each of a plurality of vessel carriers. The body also includes where each of the plurality of vessel carriers are slidable along the first internal alignment feature for presentation at the access port and each of the plurality of vessel carriers are consecutively removed from the magazine body via the access port that can be sterilized prior to opening when interfaced with an isolator port of an associated filling machine.

Implementations may include one or more of the following features. The high-density sterile magazine where each of the plurality of vessel carriers contains the vessels along an axis aligning to the access port. The access port is covered by a barrier such as a foil or non-woven material which is removed, or punctured, to facilitate removal of the plurality of vessel carriers. The plurality of vessel carriers has a removal feature at one end for receiving a removal hook. The removal feature is an opening. The high-density sterile magazine of any one to 6 may include a second internal alignment feature for the plurality of vessel carriers, the first internal alignment feature is aligned with the access port and the second internal alignment features is opposite parallel wall of the access port. The alignment feature form a slot within an end of the magazine body for receiving an respective edge of the plurality of vessel carriers. The plurality of vessel carriers contains a plurality of vials, syringes or ampules. The sterilisable port interfaces with a receiving port and a seal on the port is sterilized before removal and access to the plurality of vessels on the interior of the magazine. The port interfaces with a receiving port of a filling machine, where the port is sterilized by ultraviolet sterilization, ethylene oxide, radiation sterilization, chemical sterilization or heat sterilization. The method where the magazine is a generally rectangular body, where the port is positioned at one edge of a generally rectangular body and is placed at a lower position than an opposite edge of the generally rectangular body to allow the plurality of vessel carriers to slide internally in the magazine by gravity as each of the plurality of vessel carriers are removed.

Implementations may include one or more of the following features. The method where the magazine is a generally rectangular body, where the port is positioned at one edge of a generally rectangular body and is placed at a lower position than an opposite edge of the generally rectangular body to allow the plurality of vessel carriers to slide internally in the magazine by gravity as each of the plurality of vessel carriers are removed.

FIG. 1 shows a perspective view of a high-density sterile magazine 100 with a sealed access port. The high-density sterile magazine 100 is generally rectangular in shape, offering optimized storage density. A plurality of vessel carriers are stored in the magazine prior to being loaded into a filling machine. A body 110 is formed with sides 112 and 114 with sealed parallel openings at either end 120 and 122 of the body. The ends 120 and 122 may be open while the vessel carriers are loaded into the body 110 and subsequently sealed by installation of end sides. An air permeable barrier such as a non-woven material resistant to bacterial penetration such as Tyvek™ can be applied to one or both ends 120 and 122 of the body 110 to allow airflow out of the magazine while maintaining a sterile environment. The body 110 can be made of a dimensional stable material such as but not limited to Polyoxymethylene (POM).

FIG. 2 shows a perspective view of the high-density sterile magazine with an open access port where the air permeable barrier on end 120 has been removed exposing the access port opening 220. The access port opens perpendicular to the end of the vessel carriers, facilitating easy access. Each vessel carrier securely holds the vessels along an axis aligning with the access port. A removable or puncture-able barrier such as covers the access port, ensuring sterility is maintained until access is required. Additionally, each vessel carrier has an opening at one end to accommodate a removal hook, streamlining the retrieval process. The port may alternatively be covered by a door which can be opened to expose the interior of the magazine 100. The vessel carriers are loaded into the magazine prior to the body of the carrier being sealed. The magazine may also be placed in a sealed package for transportation and removed prior to initiating the filing process. The barrier or cover may be sterilized before puncturing to expose the access port.

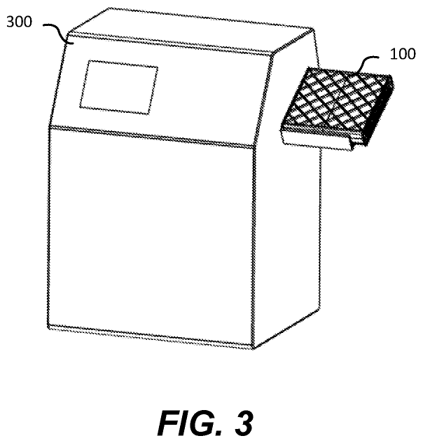

FIG. 3 shows a perspective view of the high-density sterile magazine 100 in a loading position of an exemplary filling machine 300. The magazine 100 is placed in a loading position in the filling machine 300. The magazine 100 may be positioned such that the side with the port is positioned lower than the opposite side, such that gravity assists in sliding the vessel carriers towards the opening and entry into the filling machine 300.

The operation of the high-density sterile magazine 100 involves interfacing the access port with the receiving isolator port of a filling device, opening the access port to expose the interior of the magazine by puncturing external barrier, and extracting the first carrier of the vessel carriers. Subsequent carriers can be extracted as well, with each subsequent carrier sliding to replace the position of the previous carrier that has been removed.

The method of operating a high-density sterile magazine may interface with a receiving isolator port of the filling machine. This ensures a secure connection between the magazine and the filling device prior to entering the sterile environment of the interior of the machine. The access port of the magazine is sterilized, effectively eliminating any potential contaminants and ensuring a sterile environment. The access port can be sterilized depending on the level of sterilization required and may be done by methods such as ultraviolet (UV) sterilization, ethylene oxide, radiation sterilization, chemical sterilization or heat sterilization. Once the port is sterilized, it is opened, exposing the interior of the magazine. Alternatively a sterile transfer port may be utilized. A first carrier of the plurality of vessel carriers is extracted from the interior of the magazine. This process allows for the sequential removal of vessel carriers from the magazine, enabling efficient handling and utilization of the vessels.

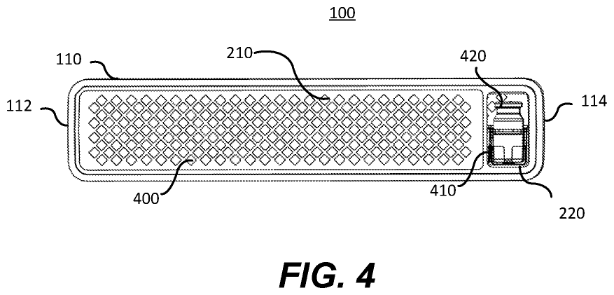

FIG. 4 shows a front end 210 view of the high-density sterile magazine 100. The front end 210 can provide multiple openings 400 to allow air pass through the magazine which are exposed when a covering is removed if present. The opening 220 allow access to the vessel carrier 410 containing vials 420. The vessel carriers 410 can be removed from the magazine 100 by engagement by a hook with an opening in the vessel carrier 410.

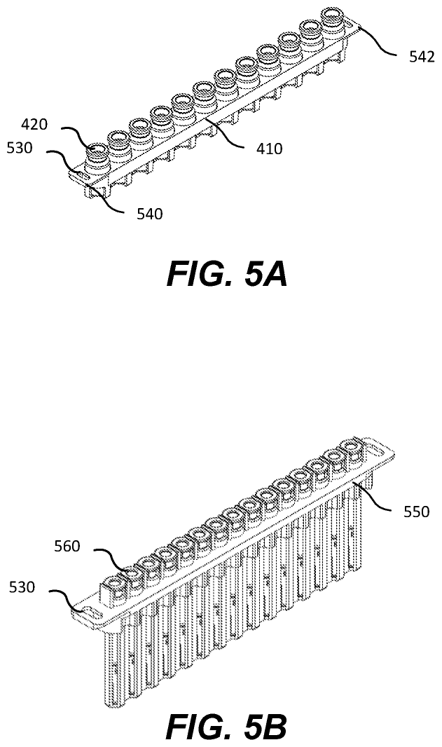

FIG. 5A shows is a view of the vessel carrier 410 containing vials 420. An opening 530 at a first end 540 facilitates removal of the vessel carrier 410 from the magazine 100. The first end 540 and second end 542 are profiled to mate with a matching feature within the magazine to allow alignment within the magazine 100. The vessel carrier 410 can also have features to allow ease of movement of the carrier through the filling machine or removal of the vials 420 such as an indentation or ledge which can be mechanically grasped to allow removal. FIG. 5B shows a view of the vessel carrier 550 containing syringes 560. An opening 530 at a first end 540 facilitates removal of the vessel carrier 550 from the magazine 100. The dimensions of the magazine 100 would be modified to accommodate the different type of vessels being carried there in. For example, the height of the magazine would be larger for syringes as opposed to vials.

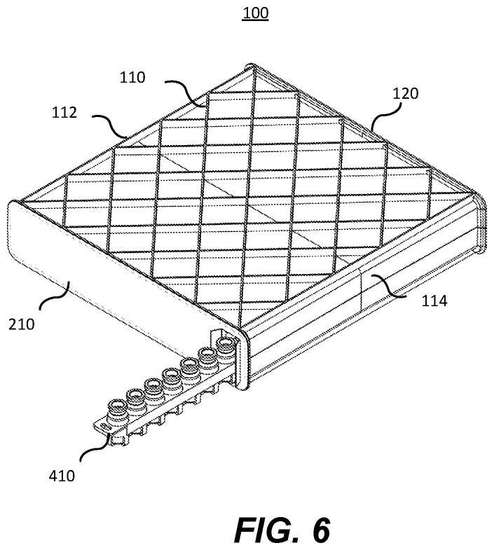

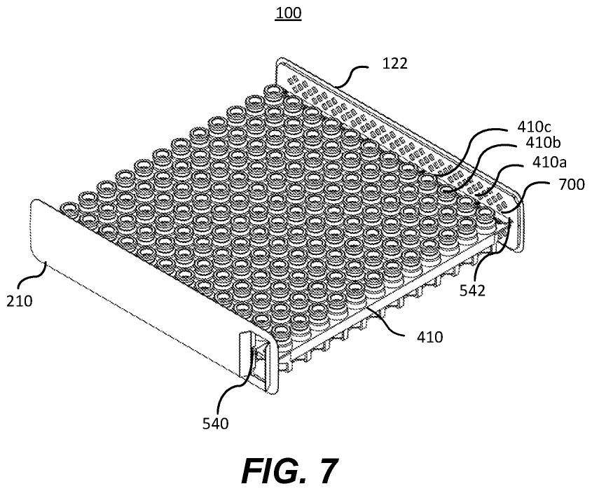

FIG. 6 shows is a view a vessel carrier 410 being removed from the high-density sterile magazine 100. As the vessel carrier 410 is remove from the magazine the next carrier slides into place in the opening of the magazine 100. The vessel carriers 410 are removed sequentially as shown in the interior view of FIG. 7. The alignment feature 700 can be a slot or channel formed within the ends 210 and 122 which receive the features 540 and 542 of the vessel carrier 410. In some embodiments, the magazine includes two alignment features at the front 210 and back 120 to enable alignment of the vessel carrier with the sterilisable or sterilized access port 220, enhancing alignment precision. Vessel carriers 410 a-410c slide along both the first and second internal slots to align with the opening of the port.

The described high-density sterile magazine can be utilized within a system for filling sterile vessels. This system includes the high-density sterile magazine and a vessel filling machine with an isolator port. The machine receives the high-density sterile magazine and extracts the vessel carriers into the filling machine for further processing.

The high-density sterile magazine and its associated method and system provide an efficient and hygienic solution for transportation, storage, and filling of sterile vessels. The magazine's design optimizes storage density, ensures sequential vessel presentation, and maintains sterility throughout the process, enhancing productivity and safety in medical, pharmaceutical, and laboratory manufacturing settings.

It would be appreciated by one of ordinary skill in the art that the system and components shown in FIGS. 1-7 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A high-density sterile magazine for transportation of a plurality of vessels, the magazine comprising:
a magazine body;
an access port providing access to a sterile interior volume of the magazine body; and
a first internal alignment feature in the interior of the magazine body, the first internal alignment feature for receiving an edge of each of a plurality of vessel carriers;
wherein each of the plurality of vessel carriers are slidable along the first internal alignment feature for presentation at the access port and each of the plurality of vessel carriers are consecutively removed from the magazine body via the access port when interfaced with an isolator port of an associated filling machine.

2. The high-density sterile magazine of claim 1 wherein the magazine is generally rectangular body and the access port opens perpendicular to the an end of the plurality of vessel carriers.

3. The high-density sterile magazine of claim 1 wherein each of the plurality of vessel carriers contains the vessels along an axis aligning to the access port.

4. The high-density sterile magazine of claim 1 wherein the access port is covered by a barrier such as a foil or non-woven material resistant to bacterial penetration which is removed, or punctured, to facilitate removal of the plurality of vessel carriers.

5. The high-density sterile magazine of claim 1 wherein the plurality of vessel carriers has a removal feature at one end for receiving a removal hook.

6. The high-density sterile magazine of claim 5 wherein the removal feature is an opening.

7. The high-density sterile magazine of claim 1 further comprising a second internal alignment feature for the plurality of vessel carriers, the first internal alignment feature is aligned with the access port and the second internal alignment features is opposite parallel wall of the access port.

8. The high-density sterile magazine of claim 1 wherein each of the plurality of vessel carriers slide along the first and second internal alignment features to align with an opening of the access port.

9. The high-density sterile magazine of claim 8 wherein the plurality of vessel carriers slide towards the opening when the magazine is oriented with the port lower than a top portion of the magazine.

10. The high-density sterile magazine of claim 1 wherein the alignment feature form a slot within an end of the magazine body for receiving an respective edge of the plurality of vessel carriers.

11. The high-density sterile magazine of claim 1 wherein the plurality of vessel carriers contains a plurality of vials, syringes or ampules.

12. The high-density sterile magazine of claim 1 wherein the access port interfaces with a receiving port and a seal on the port is sterilized before removal and access to the plurality of vessels on the interior of the magazine.

13. The high-density sterile magazine of claim 1 wherein the port interfaces with a receiving port of a filling machine, wherein the port is sterilized by ultraviolet sterilization, ethylene oxide, radiation sterilization, chemical sterilization or heat sterilization.

14. The high-density sterile magazine of claim 1 wherein the port is a movable door.

15. The high-density sterile magazine of claim 1 wherein the plurality of vessel carriers are loaded into the magazine prior to installation of a side of the magazine.

16. A method of operating a high-density sterile magazine comprising:
interfacing a port defined in a side of the sterile magazine with a receiving isolator port of a filling device;
opening the port of the magazine exposing an interior of the magazine; and
extracting a first carrier of a plurality of vessel carriers from the interior of the magazine; and
extracting a subsequent carrier of the plurality to carriers from the interior of the magazine wherein the subsequent carrier slides to replace a position of the first carrier.

17. The method of claim 16 wherein the magazine is a generally rectangular body, wherein the port is positioned at one edge of a generally rectangular body and is placed at a lower position than an opposite edge of the generally rectangular body to allow the plurality of vessel carriers to slide internally in the magazine by gravity as each of the plurality of vessel carriers are removed.

18. The method of claim 17 wherein the plurality of vessel carriers are moved by a hook or latch.

19. A system for filling sterile vessels, the system comprising:
a high-density sterile magazine containing a plurality of vessels in a plurality of vessel carriers; and
a vessel filling apparatus having a isolator port for receiving the high-density sterile magazine and extracting a plurality of vessel carriers from the high-density sterile magazine into the vessel filling machine;
wherein each of the plurality of vessel carriers are slidable for presentation at an isolator port of the vessel filling apparatus each of the plurality of vessel carriers are consecutively removed from the magazine.

20. The system of claim 19 wherein the high-density sterile magazine further comprises:
a magazine body;
an access port providing access to a sterile interior volume of the magazine body; and
a first internal alignment feature in the interior of the magazine body, the first internal alignment feature for receiving an edge of each of a plurality of vessel carriers wherein the plurality of vessels carriers are removed via the access port that when interfaced with an isolator port of an associated filling machine.
